(19) United States
(12) Patent Application Publication
(10) Pub. No.: US 2026/0353523 A1
(43) Pub. Date: Nov. 5, 2026

(54) METHOD AND DEVICE FOR CONTINUOUS DIRECT RECYCLING OF PLASTIC WASTE

(71) Applicant: RITCHIE TECHNOLOGY PTY LTD

(72) Inventor: William Ritchie, Gisborne (AU)

(21) Appl. No.: 19/119,835

(22) PCT Filed: Oct. 10, 2023
(86) PCT No.: PCT/AU2023/050995

§ 371 Date: Apr. 10, 2025

(30) Foreign Application Priority Data
Oct. 10, 2022 (AU) 2022902963

(51) Int. Cl. H05B 6/10; B29B 13/02; B29B 17/00; H05B 6/06

(52) U.S. Cl. CPC H05B 6/108; B29B 13/022; H05B 6/067; B29B 2017/0089

(57) ABSTRACT

The invention is a method and devices for continuous, direct recycling of post-consumer plastic waste. This method and device enables large volumes of waste to be processed efficiently.

### CROSS-REFERENCE TO RELATED APPLICATION(S)

This Application is a Section 371 National Stage Application of International Application No. PCT/AU 2023/050995, filed Oct. 10, 2023 and published as WO 2024/077341 A1, in English, and further claims priority to Australian Application Ser. No. 2022902963, filed Oct. 10, 2022.

### FIELD

The present invention relates to a device melting of plastics, preferably for recycling of plastic waste, and the method relating to using said device.

### BACKGROUND

Plastics are used to manufacture a significant number of products every day. More than 8.3 billion tonnes of plastic have been produced between the early 1950s and 2015. As of 2021, the world produces approximately 300 million tonnes of plastic waste every year, growing at an annual rate of 9%. Globally, there is about 8.3 billion tons of plastic in the world, over 6.3 billion of which ends up in landfill, with only 8.7% being recycled. Whilst a large percentage of this is based on the user, plastic recycling plants also face challenges in terms of its laborious and costly nature.

The process for recycling plastic usually involves separating the plastics, heating into a molten form and pelletising. Most existing plastic processing machines can only process a single type of plastic and cannot accommodate blends of plastic which is typical of plastic obtained from recycling and waste processing.

The greatest challenges in recycling plastics include excessively high capital costs and the need to separate waste by polymer type. This is often done using sophisticated energy consuming separation machinery which can be non-environmentally friendly and result in high running costs. The total cost of energy can equate to three times that of producing original plastic. Herein lies the need for a single recycling device which can handle a wide variety of post-consumer plastic waste.

It would therefore be beneficial provide a method and devices for continuous, direct recycling of post-consumer plastic waste into intermediate and usable products. The device as shown in PCT international patent application ser. no. PCT/IN01/00096 (published as WO 0238276 A1) is capable of recycling a variety of plastic waste by pushing it towards a frictional heater which heats at varying degrees to melt the different types of plastic. However, this requires the use of a diesel internal combustion engine to operate, which is not energy efficient and is costly.

The device of PCT international patent application ser. No. PCT/GB2005/000493 (published as WO 2005080060 A1) also allows for providing a volume of plastic waste comprising a variety of plastic types to be melted together, thereby removing the need for a separation machine. The waste is heated and at least some of the volume of waste is melted to form a flowable plastic melt which encapsulates and supports the non-molten plastic waste. This plastic melt flows from the heating zone to the outlet under the influence of gravity.

Notwithstanding this, the device is quite sophisticated and incorporates many moving parts. There is a rotatable operating handle for manually indexing a mould cavity support member for rotation of the chassis. There is also a mould plate which slides upon a base plate and is guided for reciprocating movement between three indexed positions. A tray receives solidified plastic waste blocks from the mould cavities and projects sideways therebeyond.

It also requires a fractional HP reversible geared electric motor connected into the electrical control circuit through suitable forward and reverse switches for manual override of automatic indexing according to a pre-set programmed cycle under the control of the PLC. An electric motor is used with a drive shaft which runs in appropriate bearings, has two spur gears and a sprocket which meshes with a chain to index the mould plate through a rack and pinion. A slipping clutch and override facility for manual indexing is also provided if required. There are three indexed positions in each direction of movement of the mould plate, namely a filling position of a mould cavity, a cooling position of the filled mould cavity and an ejection position for a solidified product formed in that mould cavity.

Therefore, it would be beneficial to provide a device for processing of plastics which is capable of simply and inexpensively processing a various forms of plastic wastes.

The reference in this specification to any prior publication or information derived from it, or to any matter which is known is not and should not be taken as an acknowledgement or admission or any form of suggestion that prior publication, or information derived from it, or known matter, forms part of the common general knowledge in the field of endeavour to which this specification relates.

### SUMMARY

According to a first aspect of the invention there is provided a device for melting of thermoplastics, the device comprising:
a vessel configured to contain molten thermoplastics, the vessel comprising an outer vessel wall;
an induction system configured to direct electromagnetic radiation into the vessel;
a susceptor located within the vessel and configured to receive electromagnetic radiation from the induction system and thereby generate heat,
wherein heat produced by the susceptor melts thermoplastics within the vessel.

In an embodiment, the induction system is configured to direct electromagnetic radiation through the outer vessel wall.

In an embodiment, the induction system comprises induction coils arranged around the outer vessel wall.

In an embodiment, the coils are arranged so as to induce even heating in the susceptor.

In an embodiment, the coils are closer together and taper towards the base of the susceptor.

In an embodiment, the outer vessel wall comprises a ceramic material enabling electromagnetic radiation from the induction system to pass therethrough.

In an embodiment, the outer vessel wall further comprises an electromagnetically conductive material at a low concentration to provide a minor amount of heating as the electromagnetic radiation passes therethrough.

In an embodiment, the vessel comprises an inlet and an outlet and is configured for continuous flow operation.

In an embodiment, the outlet is located below the inlet to enable flow through the vessel via gravity.

In an embodiment, the vessel wall tapers between the inlet and the outlet.

In an embodiment, the vessel wall tapers toward the outlet.

In an embodiment, general shape of the vessel between the inlet and the outlet is: conical, frusto-conical, or pyramidal.

In an embodiment, the susceptor tapers between the inlet and the outlet.

In an embodiment, the susceptor tapers toward the outlet.

In an embodiment, the general shape of the susceptor is: conical, frusto-conical, or pyramidal.

In an embodiment, both the vessel wall and the susceptor taper toward the outlet.

In an embodiment, the susceptor comprises a greater taper than the vessel wall to provide a melt region within the vessel between the susceptor and the outlet.

In an embodiment, the susceptor tapers to a base member, the base member further comprising a resistance heater and drainage openings enabling molten plastic to pass through the base member.

In an embodiment, the inlet comprises a loading shoot protruding into the vessel.

In an embodiment, at least a portion of the susceptor surrounds the loading shoot where the loading shoot protrudes into the vessel.

In an embodiment, a gap is provided between the loading shoot and the susceptor where the susceptor surrounds the loading shoot.

In an embodiment, the device further comprises a secondary heating system surrounding a region of the vessel proximate the outlet.

In an embodiment, the susceptor comprises a metallic material.

In an embodiment, the susceptor comprises a ferrous material.

In an embodiment, the susceptor comprises steel.

In an embodiment, the susceptor is configured to enable molten plastic to pass therethrough.

In an embodiment, the susceptor comprises susceptor elements configured:
to receive electromagnetic radiation from the induction system to generate heat; and
enable molten plastic to pass between the susceptor elements.

In an embodiment, the susceptor elements are formed of metal strips.

In an embodiment, substantially all of the susceptor elements are arranged to be in proximity with the vessel wall.

In an embodiment, the susceptor elements are concentrically arranged.

In an embodiment, the inlet comprises a loading shoot protruding into the vessel.

In an embodiment, the device further comprises a ventilation system for extracting airborne particles, water vapor and volatile gasses from the vessel during the melting process.

In an embodiment, the ventilation system comprises an internal plenum located in an upper portion of the vessel.

In an embodiment, the device comprises a flange substantially extending between the susceptor and the vessel wall, the flange configured to separate the internal plenum from the remainder of the vessel and substantially prevent molten plastic from entering the ventilation system.

In an embodiment, the flange extends from the susceptor.

In an embodiment, the device further comprises a temperature monitoring system for monitoring the temperature of the susceptor.

In an embodiment, the temperature monitoring system comprises thermocouples attached to the susceptor.

In an embodiment, the device is configured such that operation of the induction system may be controlled based on results provided by the temperature monitoring system.

In an embodiment, the susceptor is suspended within the vessel.

In an embodiment, the device further comprising a polymer pump or extruder configured to distribute molten polymer exiting the vessel.

According to a second aspect of the invention, there is provided a method of melting thermoplastics comprising melting the thermoplastics within the device of any one of the previous claims.

In an embodiment, the method comprises melting used thermoplastics for recycling.

Throughout this specification and the claims which follow, unless the context requires otherwise:
terms such as “side,” “end,” “top,” “bottom,” and the like are only used to describe elements as they relate to one another, but are in no way meant to recite specific orientations of the device, to indicate or imply necessary or required orientations of the device, or to specify how the invention described herein will be used, mounted, displayed, or positioned in use;
all referenced publications, patents and patent applications are herein incorporated by reference in their entirety to the same extent as if each individual publication, patent, or patent application was specifically and individually indicated to be incorporated by reference in its entirety;
the term “or” is inclusive to mean “and/or”;
the terms “a” and “an” are to be understood as meaning one or more;
the terms “first”, “second”, “third”, etc. are used merely as labels, and are not intended to impose numerical requirements on or to establish a certain ranking of importance of their objects; and
the word “comprise” and variations thereof such as “comprises” and “comprising”, will be understood to include the inclusion of a stated integer or step or group of integers or steps but not the exclusion of any other integer or step or groups of integers or steps.

### BRIEF DESCRIPTION OF THE FIGURES

It will be convenient to further describe the invention with reference to the accompanying drawings which illustrate a preferred embodiment of the apparatus according to the present invention. Other embodiments are possible, and consequently, the particularity of the accompanying drawings is not to be understood as superseding the generality of the preceding description of the invention.

FIG. 1 shows a melt system incorporating a melt device according to an embodiment of the invention.

FIG. 2 shows the internal configuration of a melt device according to an embodiment of the invention.

FIG. 3 shows a cross section of a melt device according to an embodiment of the invention, wherein inductor coils wrap more closely about the melt vessel toward the outlet.

FIG. 4 shows a cross-sectional view of a susceptor according to an embodiment invention, the susceptor tapering toward a base member.

FIG. 5A shows a horizontal cross-sectional view of the susceptor channel according to an embodiment of the invention, the susceptor channel being enclosed to provide shielding around the wires for thermocouples and auxiliary heating mechanisms.

FIG. 5B shows a vertical cross-sectional view of the susceptor channel of FIG. 5A.

FIG. 6A shows a two-dimensional vertical view of a square susceptor configuration according to an embodiment of the invention.

FIG. 6B shows a two-dimensional vertical view of a round susceptor with the load supporting bar configuration according to an embodiment of the invention.

FIG. 6C shows a profile view of a susceptor according to an embodiment of the invention, with the susceptor elements concentrically arranged and tapering toward a base member.

FIG. 6D shows a cross-sectional view of the susceptor of FIG. 6C.

FIG. 7 shows a plane section of an isolated portion of the susceptor according to an embodiment of the invention, specifically showing the configuration of susceptor elements in operation.

FIG. 8A shows a dolly or linear mechanical compression system for loose plastic according to an embodiment of the invention.

FIG. 8B shows a cumulative mass compression system for bales according to an embodiment of the invention.

FIG. 8C shows a rotary mechanical compression system according to an embodiment of the invention, the rotary mechanical comprising system comprising a single flight, large diameter screw or auger with a smaller side mounted loading shoot.

FIG. 8D shows a granular or shredder system according to an embodiment of the invention, the shredder system configured to the top of the loading shoot as an example of pre-processing equipment.

FIG. 9A shows a cross-sectional view with dimensions of an ingot produced by a device according to embodiments of the invention, whereby the ingot produced would qualify for manual handling.

FIG. 9B shows a longitudinal section with dimensions of the ingot of FIG. 9A.

### REFERENCE NUMERALS

1 Melt device
2 Polymer pump
3 Power supply
4 Further processing system
5 Bale of recyclable plastics
6 Melt vessel
7 Loading shoot
8 Susceptor
8A Susceptor elements
9 Drainage plenum
10 Outlet
11 Housing
12 Insulation
13 Induction coils
14 Conical base
14A Heating bands
16 Ventilation plenum
17 Vertical ventilation duct
17A Ventilation extraction point
18 Lid
19 Mounting bolts
20 Rigid insulator
21 Thermal break insulation
22 Power coupling
23 Susceptor gap
24 Resistance heater
25 Drainage openings
26 Channel
27 Thermocouple attachment point
28 Thermocouple wire
29 Solid polymer
30 Heating zone
31 Melt zone
32 Support
100 Processing plant

### DETAILED DESCRIPTION

In broad terms, the invention relates to a melt device, and a method of using a melt device, to continuously melt plastic waste. The melt device comprises a susceptor located within a vessel and induction heating system configured to heating the susceptor. Within the broader concept, embodiments of the melt device and method are described and defined below.

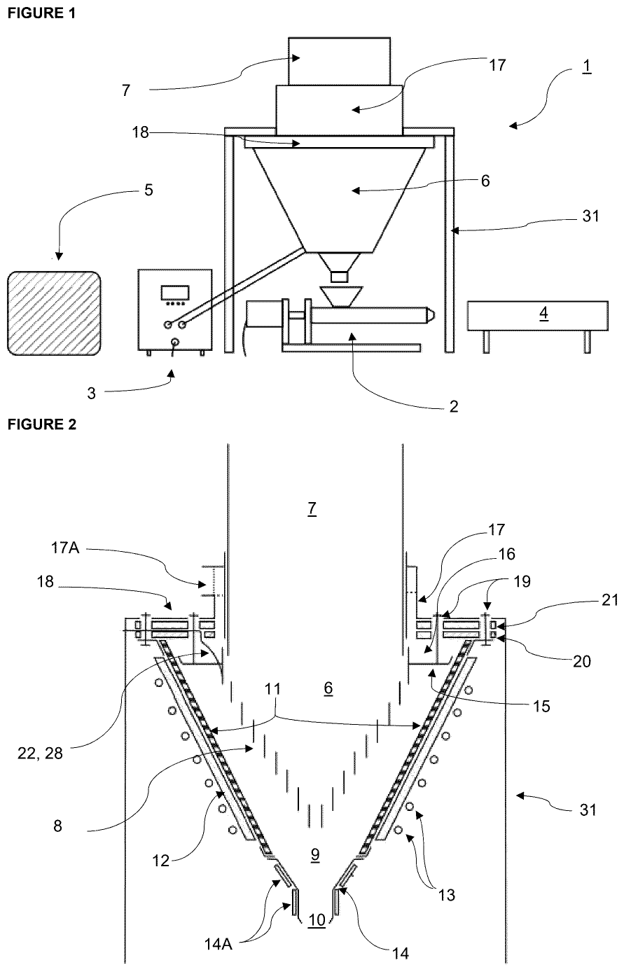

Referring to FIG. 1, a melt device 1 according to an embodiment of the invention is shown whereby the melt device 1 forms part of a plastics processing plant or system 100. The plastics processing plant 100 receives bales of recyclable plastics 5 via a loading shoot 6 located at the top of the melt device 1. The melt device 1 melts the plastic, which is then passed to a polymer extruder 2 to enable additional processing, such as the addition of stabilizers or agents or screening of the molten plastics to remove solid contaminants. Even further processing then takes place in a further processing system 4 to, for example, produce new plastic products. In this context, the further processing system may, for example, comprise a casting or moulding system for producing plastic products.

In FIG. 1 the melt device 1 receives bales of recyclable plastic 5 for melting. In other embodiments, the plastics processing system 100 may process ingots of plastic instead of, or in addition to, the bales of plastics 5. In this respect, a melt device 1 according to the invention may process plastics of any given form and is not limited to processing of bales 5, ingots, or plastic materials of any particular shape or configuration. Further, the melt device 1 need not be limited to processing of used plastic and may in certain embodiments be used to melt previously unused plastics.

Referring to FIG. 2, the internal configuration of a melt device 1 according to an embodiment of the invention is shown. The melt device 1 comprises a melt vessel 6 configured to enable flow from an inlet (formed in the embodiment shown as comprising a loading shoot 7 protruding into the melt vessel 6) to an outlet 10. In the embodiment shown, the melt vessel 6 has a generally conical shape and is vertically aligned such that the outlet 10 is provided at the bottom of the melt vessel 6 to enable gravity-assisted flow. In other embodiments, the melt vessel 6 may, for example, be frusto-conical, pyramidal, prismoidal, spherical or tubular in shape, and may be orientated vertically, horizontally or such other orientations as determined appropriate. In the embodiment shown, the melt vessel 6 is suspended from a support 31 such as a frame or scaffold that connects to the lid region 18 of the melt vessel 6. More generally, a support 31 may be provided to maintain the orientation and position of the melt vessel 6 as desired or otherwise needed.

Meltable plastic is introduced to the melt vessel 6 via a loading shoot 7 to be brought into the melt vessel 6 to a region nearby a susceptor 8. The susceptor 8 is formed of a material that absorbs electromagnetic energy and converts it into heat. The susceptor may, for example, therefore be made of certain metallic materials, such as ferrous materials e.g. steel. The susceptor 8 may, according to certain embodiments, provide the principal heating and melting means of the melt device 1 and functions by transferring heat to plastic in direct contact with the susceptor 8. As plastic melts it absorbs further heat and flows through the melt vessel 6 toward the outlet 10.

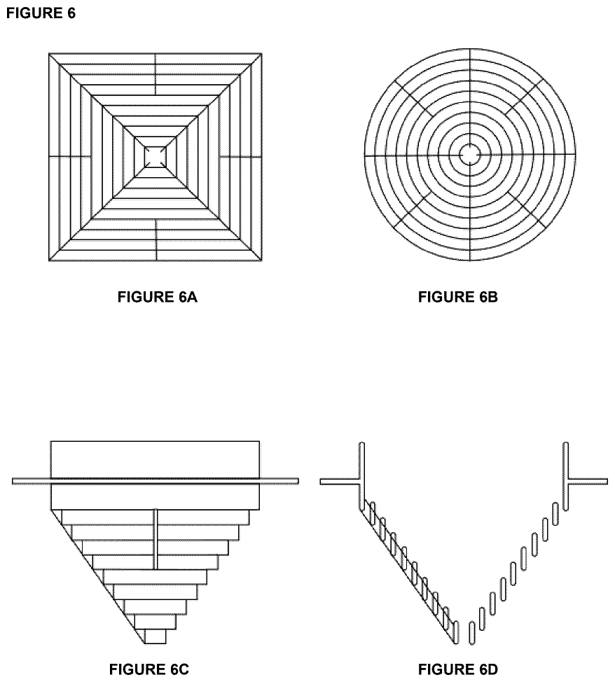

In the embodiment shown, the susceptor 8 comprises a series of susceptor elements 8A configured as bars or sheets and arranged to enable molten plastic to pass between the susceptor elements 8A and generally through gaps 23 in the susceptor 8. The susceptor elements 8A may be concentrically arranged as shown in FIG. 6 to provide for a large contact area between the susceptor 8 and the plastic to be processed. Other configurations may be used whereby, for example, plastic passes only along the outside of the susceptor 8 or, for example, where the susceptor is made of other materials in addition or alternative to steel. Steel may be seen as a preferable material given its cost, durability, and ability to convert absorbed electromagnetic energy into heat. Any number of alternative configurations may be suitable provided that the susceptor 8 is sufficiently configured to heat plastic passing through the melt vessel 6.

According to the embodiment shown, the susceptor elements 8A are positioned to generally conform with, and maintain proximity to, the outer vessel wall 11 of the melt vessel 6. This may advantageously enable the susceptor elements 8A to remain in proximity to an electromagnetic radiation source, in the present embodiment comprising induction coils 13 surrounding the outer vessel wall 11. Without wishing to be bound by theory, it is believed that providing the susceptor 8 in general proximity to the relevant electromagnetic radiation source would generally improve the energy efficiency of the heating process. In this respect, providing a melt vessel 6 and susceptor 8 that are correspondingly tapered (such as in a conical, frusto-conical, or pyramidal shape) may advantageously increase the surface area of the susceptor that is in proximity to an electromagnetic radiation source, while ensuring that heat is distributed throughout a significant volume of the melt vessel 6.

As noted above, the embodiment shown comprises induction coils 13 surrounding the outer vessel wall 11. The induction coils 13 supply electromagnetic radiation to the susceptor 8 to heat the susceptor 8. According to certain embodiments, the outer vessel wall 11 is formed of a low or no susceptance material. That is, a material that substantially does not act as a susceptor, so that electromagnetic radiation passes through the outer vessel wall 11 to the susceptor 8 without overly heating the outer vessel wall 11. The outer vessel wall 11 may therefore be formed of certain ceramic materials and other materials as may be identified by the person skilled in the art, provided that the materials used are also able to withstand within the melt vessel 6 (e.g. contact with molten plastic). In further embodiments, the composition of the outer vessel wall 11 may incorporate a low concentration of electromagnetically conductive material or otherwise be formed of a material that provides some small level of susceptance. This would enable some heating of the outer vessel wall 11 without compromising heating of the susceptor 8. The benefit of such an approach may include mitigation of heat loss from the plastic melt through the outer vessel wall.

According to certain embodiments, the lid 18 of the melt vessel 6 is comprised of a steel flange that surrounds the loading shoot 7 and connects to ventilation ducts 17 and the support 31. Since in the embodiment shown, the support 31 connects to the melt device 1 via the lid 18, the lid must withstand the load of the melt vessel 6, loading shoot 7, plastic waste, susceptor 8, and lower sections of the melt device 1. The lid 18 may therefore be reinforced with steel support beams to transfer load to the support 31. According to certain embodiments, the underside of the lid 18 is provided with insulation to provide a thermal break, exemplified in the embodiment shown as a two-part thermal break comprised of a rigid layer 20 of low thermal conductivity insulation on the internal side with a less rigid, soft layer of insulation 21 between it and the steel of the lid 18. The purpose of the thermal break is to limit system heat loss via the lid 8 and loading shoot 7 resulting in increased system efficiency.

According to certain embodiments, a backflow prevention flange 15 may be provided within the melt vessel 6 to prevent melted plastic rising into the loading shoot 7 and ventilation ducts 17, as may occur, for example, in the event of backup resulting from a reduced purging of the melt. In the embodiment shown, the backflow prevention flange 15 hangs within the melt vessel 6 from the lid 18 via a mounting bolt 19. The susceptor 8 is connected to and hangs from the backflow prevention flange 15 such that the backflow prevention flange 15 forms part of the susceptor 8. In alternative embodiments other configurations are envisaged whereby, for example, a backflow prevention flange 15 is not provided or is provided separately to the susceptor 8, or a backflow prevention flange 15 (or a susceptor 8) is positioned other than by hanging from a lid 18. In the embodiment shown, the upper portion of the susceptor 8 above and including the backflow prevention flange 15 need not be induced and heat may be carried through conduction from induced regions to non-induced regions of the susceptor 8. In other embodiments, the entirety of the susceptor may be induced to create heat in use. The upper portion of the susceptor 8 above and below the backflow prevention flange 15 conforms with the lower portion of the loading shoot 7 with a small air gap between the two.

In the embodiment shown, a loading shoot 7 is formed as a tube of cross section slightly less than the top section of the susceptor 8, and protrudes into the melt vessel 6 and into the top section of the susceptor. This creates a small air gap between the top section of the susceptor 8 and the outer surface of the loading shoot 7 to allow airflow connection to the ventilation ducts 17. The shape and size of the loading shoot 7, like other elements of the melt device 1, are configured in accordance with the design application of the melt device 1. For example, the loading shoot 7 may be configured for round or square bales of various size, or for processing single or multiple ingots of plastic for processing. In the embodiment shown, the loading shoot 7 protrudes above the external portions of the ventilation ducts 17 to accommodate several bales or a large volume of loose waste plastic.

Plastic in the loading shoot 7 can create a seal or minimal gap with the loading shoot walls but may not seal perfectly at all times. Consequently, a system of one or more ventilation ducts 17 may be provided to mitigate any convection current produced in the loading shoot 7 during heating within the melt vessel 6. In those embodiments where a ventilation duct is provided, the ventilation ducts 17 may maintain a negative pressure, thereby ensuring no or minimal airborne particles or vapors escape via the loading shoot 8 opening. In the embodiment shown, the system of ventilation ducts 17 comprises an internal ventilation plenum 16 between the backflow prevention flange 15 and the thermal break 20, 21 on the underside of the lid 18. The one or more ventilation ducts 17 connect to the lid 18 and align with apertures in the lid 18 and the thermal break 20, 21. These apertures act as the extraction points for the ventilation plenum 16 and are placed at intervals surrounding the loading shoot 7. The ventilation ducts 17 may comprise vertical ventilation shafts that connect the apertures to the ventilation plenum 16 surrounding the loading shoot 8 to vents via one or more ventilation extraction points 17A.

According to certain embodiments, a drainage plenum 9 may be provided to allow melted plastic to pool within the melt vessel 6 between walls of the vessel 6 and the susceptor 8. According to certain embodiments, a difference in angle between the susceptor 8 and walls of the vessel 6 (as discussed above) may create a widening of the drainage plenum 9 towards the base of the device 1, which acts to accommodate additional melt moving through the susceptor 8. Moreover, this configuration creates a pressure head and weight of volume of pooled plastic directly above the outlet 10. In further or alternative embodiments, the outlet 10 can be configured with a mechanical action such as a metering screw if required to enable flow of molten plastic from the melt device. In the embodiment shown, a conical base 14, which may be formed of steel, extends from the outer vessel wall 11 to the outlet 10. The diameter of the outlet 10 may be configured to the melt rate of the melt device to ensure free flowing discharge of melt. Both the conical base 14 and outlet 10 may be heated by heating bands 14A to maintain desirable flow characteristic and temperature of the melt. This additional heating of the conical base 14 and outlet 10 aids in start-up procedures to ensure that the melt can freely drain on commencement of the primary induction heating and melting processes.

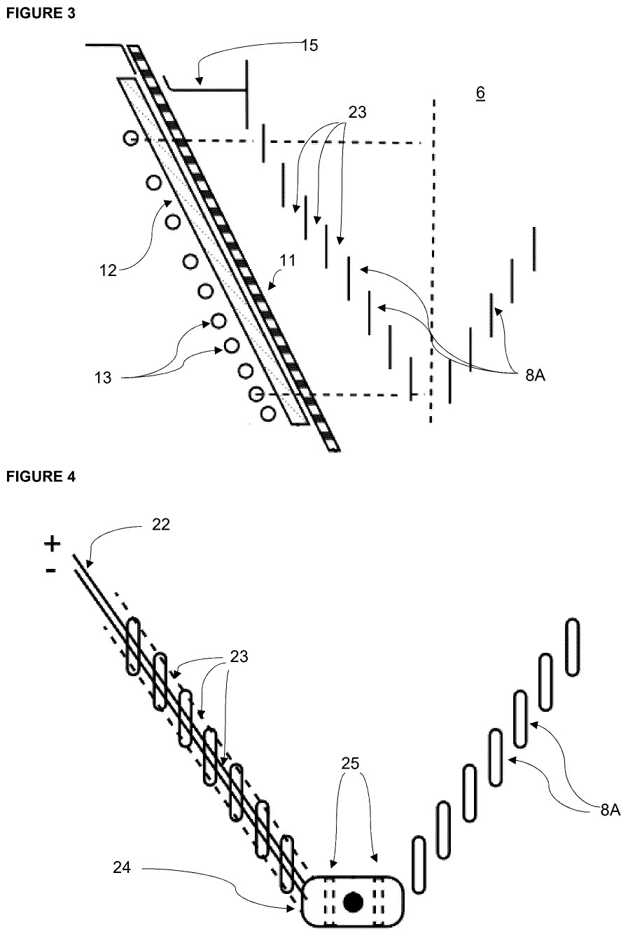

FIGS. 1 and 2 further show the principal method of heating as an induction heating system that heats the susceptor 8 mounted internally within the melt vessel 6. The induction power supply and governance system are designed and configured according to the device iteration. The induction coils 13 are fitted to the outside melt vessel 6 and, according to certain embodiments, are arranged to evenly induce heating in the susceptor 8. In other embodiments, coils windings may be concentrated closer together towards the base of the susceptor 8, as exemplified in FIG. 3. This provides a stronger magnetic field and greater heating in this region to account for the coil radius to susceptor radius ratio variation that would otherwise inhibit heating capability, particularly to the base of the susceptor 6. In further or alternative embodiments, frequency variation built into the induction power supply 3 can be adjusted to provide optimal heating conditions to maximize heat conductivity and provide even heating throughout the susceptor 8. According to certain embodiments, separating the susceptor 8 and induction coils 13 into independent zones may be provided to achieve optimal heating through the susceptor 8.

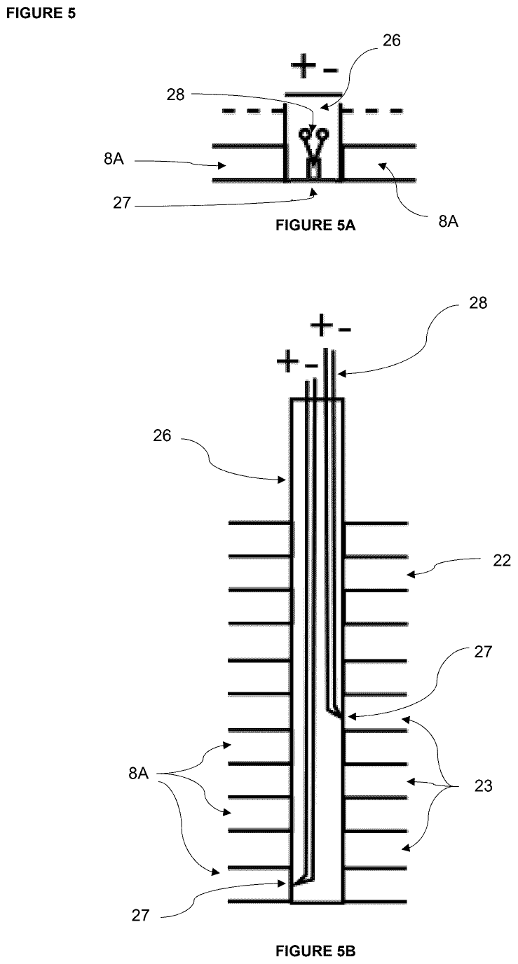

According to embodiments of the invention, a temperature monitoring system may be employed to monitor the temperature of the susceptor 8, further enabling the regulation of induction power and the control of the temperature of the susceptor 8. In the embodiment shown, the temperature monitoring system comprises a number of thermocouples, each attached to a respective susceptor element 8A. FIGS. 5A and 5B show thermocouple attachment points 27 provided within to the internal face of respective susceptor elements 8A. As noted above, thermocouples provide data which may be used to ensure precise power regulation of induction of the susceptor 8, thereby providing precise temperature control. Thermocouple wires 28 may run from thermocouple attachment points 27 through electromagnetically shielded vertical channels 26 in the susceptor 8, to ensure accuracy of measurement by eliminating electromagnetic interference. As shown, the thermocouple wires 28 may exit the device 1 via small holes in the upper portion of the susceptor 6 above the flange 15 and below the loading shoot 7. The thermocouple wires 28 may then be channeled through the ventilation plenum 16 and vertical ventilation shafts 17 where they enter channels in the soft insulation layer 20 of the thermal break 20, 21. Multiple thermocouple wires 28 can share the same channels through the thermal break 20, 21 so as to exit at the same point.

FIG. 4 shows a base 24 of the susceptor 18 according to certain embodiments as a blunt plate with drainage openings 25. This configuration is intended to limit the minimum susceptor radius and to account for a lack of induction heating at this end of the susceptor 8 (in the embodiment shown). The lack of induction heating is offset by the resistance heating mechanism within the base 24. Power to this resistance heater can be supplied via high temperature resistant insulated wiring 22 that runs through dedicated electromagnetically shielded vertical channels 26 in the susceptor 8 (as discussed above with reference to FIGS. 5A and 5B).

According to certain embodiments, a pressure gradient may be generated by either gravity (weight of feedstock, i.e., cumulative bale weight), or by addition of mechanical compression in the intake (loose, low density plastic waste). This downward force ensures even and sustained contact pressure of feedstock with the susceptor 8 and forces the resulting melt through the drainage openings 23, 25 in the susceptor 8. The weight, volume and pressure head under gravity channels the melt via a drainage plenum 9 to the outlet 10 at a rate equal too, or in excess of, the rate of melting. The resulting polymer melt is then available to a range of manufacturing processes and applications.

In the embodiment shown, the susceptor 8 comprises susceptor elements 8A formed as thin walls of flat steel bars or strips, concentrically arranged and resulting in a large internal void volume. The outer surfaces of the susceptor elements 8 are in relatively close proximity to walls of the melt vessel 6 and induction coils 13 to ensure an efficient induction heating process. The flat steel bars or strips of the susceptor 8 may run horizontally on their thin edge and are assembled in a shiplap configuration with spacings between each consecutive strip, as per the embodiments shown in FIGS. 6 A, B, C & D.

FIG. 6A shows an embodiment of the invention, wherein the susceptor 8 is provided a square or pyramidal configuration. The radiating lines represent the flat steel bars in a pyramidal and conical formation. The intersecting lines represent connecting load supporting bars that accumulate as the aperture increases.

FIG. 6B shows an embodiment of the invention, wherein the susceptor 8 is arranged in a concentric configuration of susceptor elements 8A, provided as steel strips forming hoops, with each consecutive hoop being smaller in diameter toward the base. The hoops are connected via steel bracing strips orientated with the thin edge towards the outer of the susceptor 8. These connecting strips intersect the hoops and act as a load transfer bracing with additional bracing strips added as the diameter of the hoops increases towards the top of the susceptor 8. The top forms a backflow prevention flange 15 that extends to within several millimeters of the walls of the melt vessel 6, as shown in FIG. 6C & D.

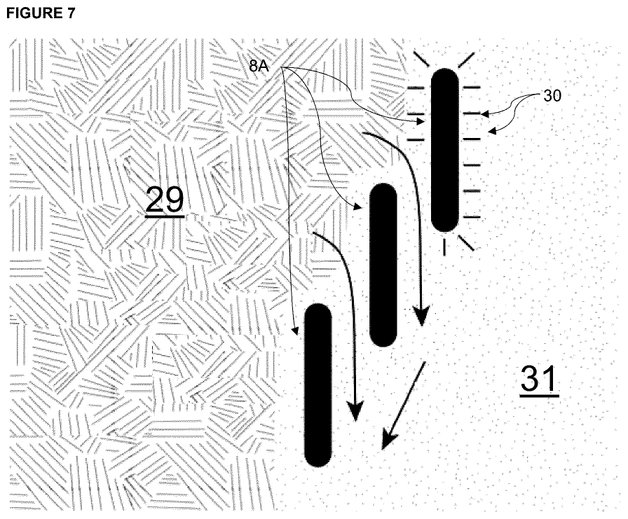

FIG. 7 shows the melt zone 31, the region in contact with susceptor elements 8A and heating zone 30 around the susceptor elements as further indicated by the radiating lines. The path of molten plastic through openings between susceptor elements 8A toward the outlet 10 of the melt vessel 6 is indicated by the arrows.

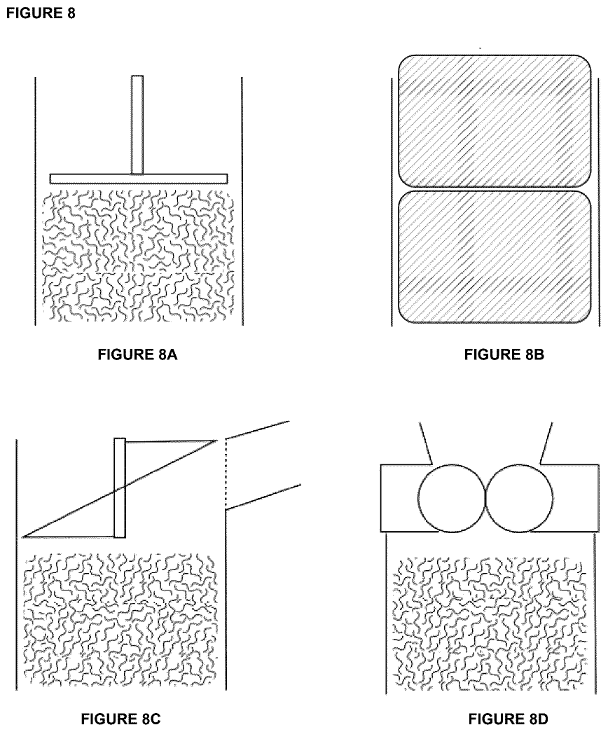

The top section of the loading shoot 8 may be customised to facilitate processing equipment and/or compression mechanisms and apparatuses, as show in different embodiments displayed in FIG. 8A, B, C & D. Loose plastic can be facilitated using a dolly or linear compression system, as per the embodiment shown in FIG. 8A. Bales can be loaded into the loading shoot 8 for a cumulative mass scenario, as per the embodiment shown in FIG. 8B. A rotary system comprising a single flight, large diameter screw or auger with a smaller side mounted loading shoot 8 is shown in the embodiment displayed in FIG. 8C. The embodiment of FIG. 8D provides an example of a pre-processing shredder, configured to the top of the loading shoot 8. The loading shoots attachment points attach to the lid section. These attachments points may be adjustable to control the proximity of the internal end of the loading shoot 8 with the intake of the susceptor 6.

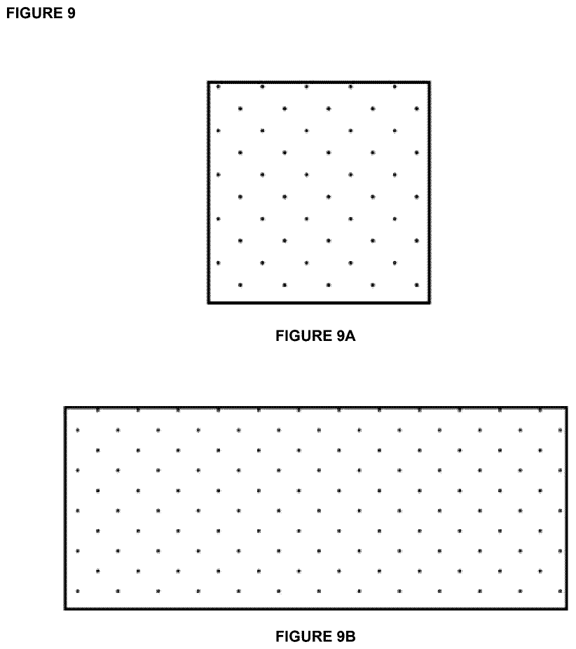

In an embodiment of the invention, the melt device 1 may be configured to produce plastic ingots from the molten plastic. FIGS. 9A and 9B show a cross-sectional and lateral section view of a form of plastic ingot to be produced as per the melt device 1. The ingots are in rectangular form and have dimensions of 200 m×200 m×500 mm and an estimated weight of approximately 19.2 kg. An ingot of this dimension would stack efficiently in layers of 10 on a standard sized pallet, whilst qualifying for manual handling in many jurisdictions.

In an embodiment, multiple melt devices 1 may form a melt system 100 coupled to a single power supply 3. Depending on the power supply capability, it is possible for a single power supply 3 to service multiple melt devices 1. Alternatively, a single power supply 3 can service multiple devices 1 independently by disconnecting and connecting power from one unit to the next. This modular capability allows different waste streams to be recycled using multiple melt devices 1 and a single power supply 3. As power supply represents a major capital cost within a melt system, utilizing a single power supply may reduce capital outlay while increasing versatility. Moreover, this approach avoids any need to purge a melt device 1 of a specific polymer or plastic waste stream in order to melt a different polymer or plastic waste stream. This modular approach is well suited to processing variable and limited supplies of waste plastic feedstock in environments where multiple feed stocks are being processed.

The melt device may serve as a single stage processing point between aggregation of plastic waste and production of recycled plastic products, thereby eliminating the need for additional processing steps and equipment otherwise commonly employed in recycling plastics. The melt device may accommodate a wide range of waste types, including mixed, damp, and contaminated waste, as well as those plastic wastes that have traditionally been considered difficult and expensive to recycle. The present invention enables continuous and efficient processing of large volumes of plastic waste.

Further, melt devices of the invention:
are well suited to all thermoplastic waste of any physical configuration such as films, packaging, and solid forms of waste.
may process waste in either loose or bale form, thereby significantly reducing existing processing requirements;
may tolerate high levels of medium to fine non-polymer contamination in the waste;
are capable of processing mixed polymer waste and damp waste;
are relatively compact, lightweight, simple, and energy efficient, with a small spatial footprint relative to output volume;
are hard wearing with no mechanical or moving parts;
are well suited to recycling applications close to the waste streams; and
are versatile in their design, which allows customisation to specific applications and volumes.

It will be understood to persons skilled in the art of the invention that modifications may be made without departing from the spirit and scope of the invention. The embodiments and/or examples as described herein are therefore to be considered as illustrative and not restrictive.

1. A device for melting of thermoplastics, the device comprising:
a vessel configured to contain molten thermoplastics, the vessel comprising an outer vessel wall;
an induction system configured to direct electromagnetic radiation into the vessel;
a susceptor located within the vessel and configured to receive electromagnetic radiation from the induction system and thereby generate heat,
wherein heat produced by the susceptor melts thermoplastics within the vessel.

2. The device according to claim 1, wherein the induction system is configured to direct electromagnetic radiation through the outer vessel wall.

3. The device according to claim 1, wherein the induction system comprises induction coils arranged around the outer vessel wall.

4. The device according to claim 3, wherein the coils are arranged so as to induce even heating in the susceptor.

5. A-The device according to claim 3, wherein the coils are closer together and taper towards the-a base of the susceptor.

6. The device according to claim 3, wherein the outer vessel wall comprises a ceramic material enabling electromagnetic radiation from the induction system to pass therethrough.

7. (canceled)

8. The device according to claim 1, wherein the vessel comprises an inlet and an outlet and is configured for continuous flow operation.

9-11. (canceled)

12. The device according to claim 8, wherein the vessel wall tapers between the inlet and the outlet and the general shape of the vessel between the inlet and the outlet is: conical, frusto-conical, or pyramidal.

13. The device according to claim 8, wherein the susceptor tapers between the inlet and the outlet.

14. (canceled)

15. The device according to claim 13, wherein the general shape of the susceptor is: conical, frusto-conical, or pyramidal.

16. (canceled)

17. The device according to claim 13, wherein the susceptor comprises a greater taper than the vessel wall to provide a melt region within the vessel between the susceptor and the outlet.

18. The device according to claim 13, wherein the susceptor tapers to a base member, the base member further comprising a resistance heater and drainage openings enabling molten plastic to pass through the base member.

19. The device according to claim 8, wherein the inlet comprises a loading shoot protruding into the vessel.

20-21. (canceled)

22. The device according to claim 8, further comprising a secondary heating system surrounding a region of the vessel proximate the outlet.

23-25. (canceled)

26. The device according to claim 1, wherein the susceptor is configured to enable molten plastic to pass therethrough.

27. The device according to claim 1, wherein the susceptor comprises susceptor elements configured:
to receive electromagnetic radiation from the induction system to generate heat; and
enable molten plastic to pass between the susceptor elements.

28-30. (canceled)

31. The device according to claim 1, further comprising a ventilation system for extracting airborne particles, water vapor and volatile gasses from the vessel during a melting process.

32. The device according to claim 31, wherein the ventilation system comprises:
an internal plenum located in an upper portion of the vessel; and
a flange substantially extending between the susceptor and the vessel wall, the flange configured to separate the internal plenum from a remainder of the vessel and substantially prevent molten plastic from entering the ventilation system.

33-34. (canceled)

35. The device according to claim 1, further comprising a temperature monitoring system for monitoring the temperature of the susceptor.

36-39. (canceled)

40. A method of melting thermoplastics comprising melting the thermoplastics within the device of claim 1.

41. (canceled)
